(19) United States
(12) Patent Application Publication
(10) Pub. No.: US 2003/0168823 A1
(43) Pub. Date: Sep. 11, 2003

(54) Snow boogie

(76) Inventor: Mike T. Lamm, Oxnard, CA (US)

Correspondence Address: Michael T. Lamm, 3600 S. Harbor Blvd. #213, Oxnard, CA, 93035, US

(21) Appl. No.: 10/036,872

(22) Filed: Oct. 26, 2001

(51) Int. Cl. B62B 13/00

(52) U.S. Cl. 280/18

(57) ABSTRACT

A steerable sledding design is disclosed which includes special modified bottom rockers or curves, snow channels, and tracking ridges. As well as, comfortable seating area, adjustable footing, custom channeled rails and handles for steering capabilities and maneuverability.

### BACKGROUND—FIELD OF INVENTION

This invention relates to light weight easy to use Snow Toy for sledding fun.

### BACKGROUND—DESCRIPTION OF PRIOR ART

Sleds and Snow related sledding products have traditionally used a design with two metal strips or “skis” with an adjustable turning handle in the front for moderate steering and control. These have been modified on different levels with many different designs. Such as U.S. Pat. No. 4,561,664 issued to Cashmere (1985) discloses a hand toboggan that accommodates a seated or kneeling rider with metal runners and allows them to turn in whichever direction he should lean, as well as, U.S. Pat. No. 5,335,925 issued to Dolson (1994) and U.S. Pat. No. 5,687,977 issued to Smith (1997). However, the drawbacks of these designs are the weight of the sleds and also the dangers of being hit or run over by the weight of the user and the metal skis. Another draw back was the expense of these snow toys for the consumer as they were using expensive metal and wood and would be laborious on the manufacturing end to produce a worthwhile product.

### OBJECTS AND ADVANTAGES

Some of the obvious objects and advantages of the present inventions are:

(a) to provide a safer high quality snow toy for maximal fun and reduce sledding injuries.

(b) to create a product that is very lightweight and easy to carry to increase hours of enjoyment.

(c) To create a snow toy that can be comfortable and still give you steering control.

(d) To introduce a product that can be esthetic and fun to use and not be overbearing to the public for over the counter retail price.

### DRAWING FIGURES

FIGS. 1A to 1F show the different materials to be used for manufacturing and different design features to the top or deck of the product.

FIGS. 2A to 2D show specific design features for function and maneuverability of the product.

FIGS. 3A to 3C show back angle to give specific view of created design features for the performance of the product.

FIGS. 4A to 4B show a bottom design for overall look and performance of the product.

### SUMMARY

In accordance with the present invention, the snow boogie is a comfortable light weight, easy to use snow sledding product that can be enjoyed by the general public at all skill levels at nearly all active age brackets.

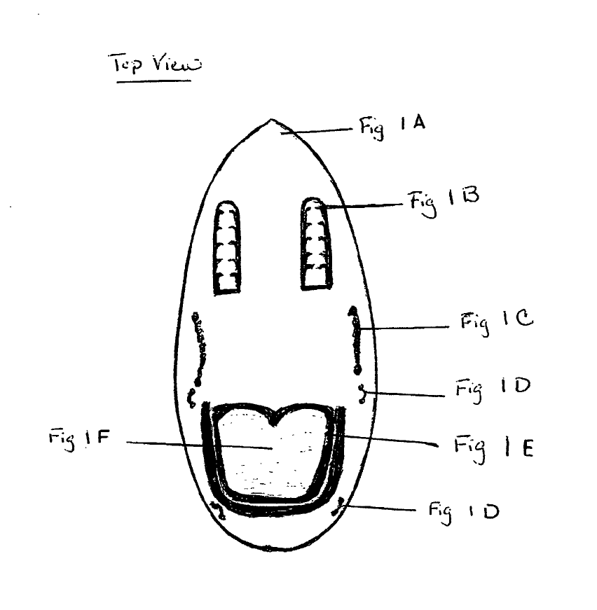

### DESCRIPTION—FIGS. 1 to 4

A typical embodiment of the present invention is Illustrated in FIGS. 1A (top view) to 2A (bottom view), 3A (back view) and 4A (side view).FIG. 1A is a top view of the product. It encompasses two different types of materials that can be used for the manufacturing of the product. One is Dow Core top and Urethane bottom that would create a lesser expensive manufacturing and retail product and two a Roto-molded Polyethylene plastic for a higher-grade product for look and function.

FIG. 1B shows an adjustable footing area that is a concaved area with multiple groves or notches that allows different resting position of the foot per the height of the user.

FIG 1C shows side handles that allow leverage to lift the product onto the turning rails for maneuverability these also assist the carrying of the product.

FIG. 1D shows plastic eye lit fasteners that are riveted to the product for the fastening of any numerous after market seats and other misc. accessories.

FIG. 1E shows a concave seat position with foam pad that specifies the exact positioning of any after market seats that can be added for user comfort.

FIG. 1F foam pad to adhere to the concave seat position for added comfort.

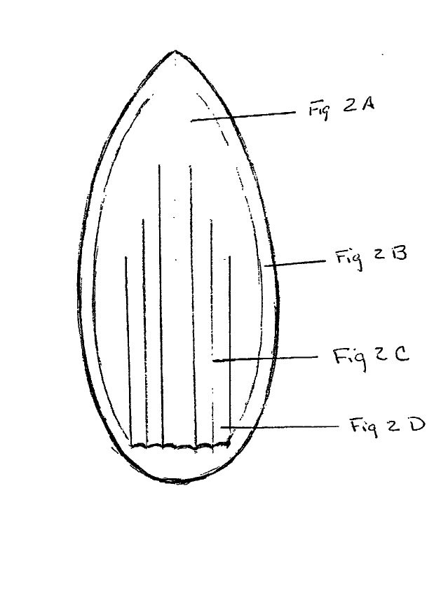

FIG. 2 shows the design and function of the bottom of the product.

FIG. 2A shows flat entry area of the bottom of the product.

FIG. 2B chimed channeled angled rails aprox 45% angle for leaning the product and steering capabilities.

FIG. 2C shows tracking ridges that are small raised area's to bite the snow and keep tracking straight with control.

FIG. 2D shows concave snow channels for speed and traction.

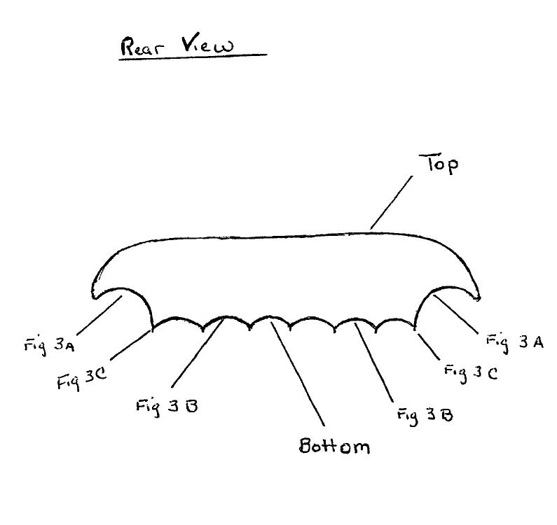

FIG. 3 shows a rear view of the product and its working design and functions.

FIG. 3A shows a rear view of the 45% chimed channel concave rail for leaning and turning capabilities.

FIG. 3B shows a rear view of the concave bottom design configuration for grip and tracking of the product, original R & D prototypes were made without this design and they did not track straight and would lose control for turning this design stabilizes that manifestation and adds control and turning capabilities.

FIG. 3C shows small stability ridges for extra grip and stability in the snow.

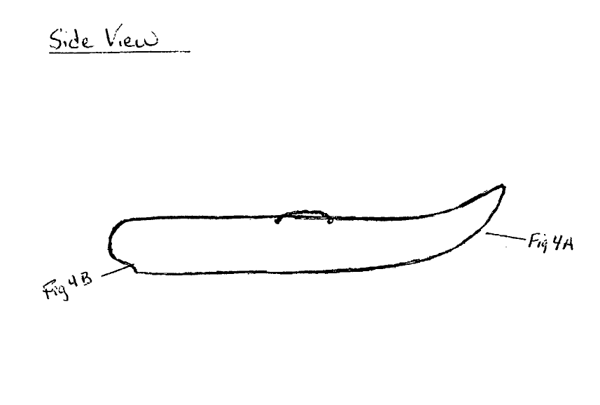

FIG. 4 shows a side view of the product.

FIG. 4A shows a nose rocker design or a lift to the front of the product to aid speed and stop from plowing into the snow.

FIG. 4B shows a slight lift or bottom curve to the rear area of the product to aid speed and maneuverability.

### SUMMARY, RAMIFICATIONS, AND SCOPE

Accordingly the reader will see that the Snow-boogie, snow sledding toy can be easily used and enjoyed by a large portion of the general public for fun and recreation. Furthermore the product has the additional advantages of

it permits adding comfort to existing designs on the market;

it introduces a safer product for moderate snow sledding fun;

it provides a lighter weight product to increase hours of enjoyment and reduces the laborious hauling of heavier existing products up and down a slope;

it provides a product with tracking and turning capabilities;

it provides a new product that can be inexpensive and still attain numerous esthetic designs;

it provides a product that is user friendly for the masses of the general public at nearly all age and skill levels.

Although the description above contains much specificity, these should not be construed as limiting the scope of the invention but as merely providing illustrations of some of the presently preferred embodiments of this invention. For example the product can have different shapes and designs or models or future design improvements ect.

Thus the scope of the invention should be determined by the appended claims and their legal equivalents, rather than by the examples given.

What I now claim is:

1. A hand held sledding product with created new design features comprising;
a) concave channeled rails for steering capabilities.
b) turning handles for leverage used for turning the said product.
c) concave snow channels for speed and straight tracking.
d) tracking ridges for extra grip and straight tracking of the said product.
e) comfortable seating area for said product user.
f) adjustable foot placement area for varying heights of said product user.
Thorough research of prior art disclosed only standard wooden toboggans and sleds with metal runners or ocean related products such as body boards and kayaks that were Hydro—Dynamic designs, specifically designed for use on the water. None of which had any specific design feature or function that was applicable to snow. Snow boogie is unique in that features, sizes, shapes, designs, and functions were specifically designed for comfort maneuverability, and performance in relating to snow sledding activities.
Extensive Research and Development and numerous prototypes were produced and improved which brought about the specific working features of this product and are said to be new creations in its field.
